(19) United States
(12) Patent Application Publication
(10) Pub. No.: US 2012/0033688 A1
(43) Pub. Date: Feb. 9, 2012

(54) Single longitudinal mode fiber laser apparatus

(75) Inventors: Shien-Kuei Liaw, Pingzhen City (TW); Hsiang Wang, Banqiao City (TW); Kai-Hsiang Hsu, Yonghe City (TW); Fu-Chun Hung, Kaohsiung City (TW); Ching-Wen Hsiao, Fengshan City (TW)

(73) Assignee: National Taiwan University of Science and Technology, Taipei City (TW)

(21) Appl. No.: 13/012,768

(22) Filed: Jan. 24, 2011

(30) Foreign Application Priority Data
Jan. 25, 2010 (TW) 099101884
Jan. 7, 2011 (TW) 100100714

(51) Int. Cl. H01S 3/10

(52) U.S. Cl. 372/20

(57) ABSTRACT

The present invention provides a single frequency fiber laser apparatus. The fiber laser apparatus includes a Faraday rotator mirror. A piece of erbium doped fiber is inside the laser cavity. A wavelength selective coupler is connected to the erbium doped fiber. A pump source is coupled via the wavelength selective coupler. At least one sub-ring cavity component and/or an absorb component are inserted into the cavity for facilitating suppressing laser side modes to create a single longitudinal mode fiber laser. A partial reflectance fiber Bragg grating (FBG) is used as the front cavity end for this fiber laser.

### CROSS-REFERENCE TO RELATED APPLICATION

This present application claims priority to TAIWAN Patent Application Serial Number 099101884 and 100100714, filed on Jan. 25, 2010 and Jan. 7, 2011 respectively, which are herein incorporated by reference.

### TECHNICAL FIELD

This invention relates to a fiber laser apparatus, and more particularly to a single longitudinal mode fiber laser apparatus.

### BACKGROUND OF THE RELATED ART

With the increasing demand for optical communication, fiber laser is an important part, especially laser source. Resonant cavity, gain medium and pump source (pump LD) composed of three basic elements in a laser apparatus. The pump source provides energy for promoting most of the electrons from ground state to higher level states as called population inversion. An inducing factor is provided for the gain medium to create the same frequency light in the cavity for resonating. When the optical power inside the cavity reaches a threshold power, laser is then created and launched outside the laser cavity. In usual, fiber laser is composed of erbium-doped fiber as gain medium, fiber gratings as reflected components to construct the cavity end. Therefore, erbium-doped fiber laser scheme is simpler than that of a commercial semiconductor laser scheme.

In general, linewidth of a laser is measured by an optical spectral analyzer (OSA). But, it is not so accuracy due to its limited resolution of around 0.05 nm. Therefore, an electrical spectral analyzer (ESA) is applied to analyze output signals which are transferred laser light into an electrical spectrum for analyzing. The later can improve data accuracy and optimize linear type fiber laser apparatus for clearly observing whether the signal is a single longitudinal mode or nor.

For example, Agilent 71200C electrical spectral analyzer is adapted a method of delayed self-homodyne (DSH) for analyzing line width which frequency range can reach 22 GHz, and therefore it can perform a very precise analysis of the measurement and available analyzer for extremely narrow linewidth such as the proposed fiber laser.

With the development of optical communication and fiber sensing, properties of the fiber component are improved significantly. Structure of the fiber component is altered by component property to improve the laser output performance. Rear cavity end of a traditional fiber laser usually comprises a fiber grating.

The fiber gratings may be disposed at two cavities as reflection ends. Optical wavelength which meets the Bragg condition of fiber grating is reflected inside the cavity, and therefore two fiber gratings (fiber grating pair) are used to the reflection end. The fiber grating is a very narrow bandwidth filter component. It is very difficult to precisely align the wavelength of fiber grating pair for obtaining the best result of laser output. Initially, the reflected wavelength of the two fiber gratings is fixed. If central wavelength of fiber laser needs to be changed, then the reflected wavelength of the fiber grating pair must be changed simultaneously for realizing the wavelength tunable purpose, and thereby reducing such scheme usage.

The optical circulator based fiber laser is limited by work band the optical circulator. For pump laser, it can not effectively lead back to the cavity for reuse.

Moreover, erbium-doped fiber laser comprises both linear type and ring type scheme. The linear type scheme has the advantages including simpler structure, larger better free spectral range (FSR) thank to shorter cavity length. The ring type erbium-doped fiber laser is rather complicated, expensive, and polarization fluctuation due to longer cavity length.

Single frequency fiber laser means that laser has only a single longitudinal mode mode which has the advantages including narrow laser linewidth, small mode impact, higher SNR and more stable laser output. It can apply to demand for high-speed and long-haul transmission. Ring type fiber laser is more popular currently because light wave travels in unidirection. However, in the linear type cavity, light wave exists by a standing wave which is mutual injection in the cavity, and therefore mode impact is larger than that in a ring type cavity.

Currently, single longitudinal mode fiber laser can be made by the following methods: (1). short-cavity method: a shorter laser cavity length with a wider frequency spacing between the laser modes, single longitudinal mode resonating into the cavity when the frequency spacing is over gain bandwidth of laser output; (2). Ring-type cavity method: in the linear fiber laser cavity, light wave propagates inside the cavity in standing wave to insure stable mode, if the cavity is designed as ring structure, light wave can propagate by a travelling wave such that light transmits by a single direction to reduce mutual injection between modes for generating single longitudinal mode laser; (3). Etalon method: in laser cavity, a suitable optical Eatlon, for example Fabry-Perot interferometer, can suppress laser side modes and only allow a specified frequency laser passing through the Etalon for resonating; (4). Filter method: adding a filter into the laser cavity, rotating its angle such that laser creates a phase delay, when the frequency spacing of laser output is over its gain-bandwidth, a single longitudinal mode laser will be created.

While manufacturing of single longitudinal mode fiber laser is mainly ring type scheme, rather than linear type fiber laser. Therefore, the present invention provides a newly single longitudinal mode fiber laser apparatus to overcome the aforementioned problem and effectively form a single longitudinal mode fiber laser.

### SUMMARY

The present invention provides a single longitudinal mode fiber laser apparatus comprises a fiber component; a wavelength division multiplexer coupled to the fiber grating; a pump source coupled to the wavelength division multiplexer; a wavelength tunable or wavelength non-tunable as a front cavity end for the fiber laser apparatus; and an absorber component and/or at least one sub-ring cavity component inserting into the cavity for facilitating suppressing laser side modes to create a single longitudinal mode fiber.

The single longitudinal mode fiber laser apparatus further comprises a Faraday rotator mirror coupled to the fiber component, wherein Faraday rotator mirror comprises a broadband fiber mirror and a Faraday rotator.

According to another aspect of the present invention, the single longitudinal mode fiber laser apparatus further comprises a polarization controller coupled the wavelength division multiplexer and the sub-ring cavity component or the absorber component.

According to yet another aspect of the present invention, the single longitudinal mode fiber laser apparatus further comprises an optical circulator coupled to the fiber component or a broadband fiber mirror coupled to the fiber component.

The sub-ring cavity component comprises a first optical coupler, a second optical coupler and an optical circulator, wherein the first optical coupler, the second optical coupler and the optical circulator are serially configured into a sub-ring cavity to form two optical paths. The absorber component is coupled to the at least one sub-ring cavity component or the absorber component is inserted into the at least one sub-ring cavity component.

### BRIEF DESCRIPTION OF THE DRAWINGS

FIG. 1 illustrates a Faraday rotator mirror.

FIG. 2 illustrates a forward FRM type linear fiber laser scheme.

FIG. 3 illustrates an output spectrum of the forward FRM type fiber laser.

FIG. 4 illustrates a backward FRM type linear fiber laser scheme.

FIG. 5 illustrates a clean output spectrum of fiber laser.

FIG. 6 illustrates an optical spectrum graph in the backward pumping scheme.

FIG. 7 illustrates a FRM type backward pumping scheme with a polarization controller according to the present invention.

FIG. 8 illustrates an output spectrum of fiber laser measured by an electrical spectrum analyzer (ESA).

FIG. 9 illustrates a FRM type backward pumping scheme with a sub-ring cavity (SRC) according to the present invention.

FIG. 10 illustrates an electrical spectrum of a FRM type backward fiber laser, with a 0.5 m sub-ring cavity.

FIG. 11 illustrates an electrical spectrum of a FRM type backward fiber laser, with a 0.17 m sub-ring cavity.

FIG. 12 illustrates a FRM type backward pumping scheme with an absorber according to the present invention.

FIG. 13 illustrates an electrical spectral graph of a FRM type backward fiber laser, with a 0.5 m absorber.

FIG. 14 illustrates a FRM type wavelength tunable single longitudinal mode fiber laser scheme with a sub-ring cavity according to the present invention.

FIG. 15 illustrates a FRM type wavelength tunable single longitudinal mode fiber laser scheme with an absorber component according to the present invention.

FIG. 16 illustrates a mixed type FRM single longitudinal mode fiber laser apparatus or scheme according to the present invention.

FIG. 17 illustrates another mixed type FRM single longitudinal mode fiber laser apparatus or scheme according to the present invention.

FIG. 18 illustrates a cavity component according to the present invention.

FIG. 19 illustrates an optical circulator type fiber laser apparatus.

FIG. 20 illustrates an output spectrum of OSA of the optical circular type fiber laser apparatus.

FIG. 21 illustrates an output spectrum of ESA of the optical circular type fiber laser apparatus.

FIG. 22 illustrates a single sub-ring cavity optical circulator type fiber laser scheme according to the present invention.

FIG. 23 illustrates a structure of the sub-ring cavity according to the present invention.

FIG. 24 illustrates an output spectrum of ESA of the optical circular type fiber laser apparatus.

FIG. 25 illustrates a two sub-ring cavity optical circulator type fiber laser scheme according to the present invention.

FIG. 26 illustrates an output spectrum of ESA of the optical circular type fiber laser apparatus.

FIG. 27 illustrates a three sub-ring cavity optical circulator type fiber laser scheme according to the present invention.

FIG. 28 illustrates an output spectrum of ESA of the optical circular type fiber laser apparatus.

FIG. 29 illustrates a structure of the sub-ring cavity component according to the present invention.

FIG. 30 illustrates a structure of the sub-ring cavity component according to the present invention.

FIG. 31 illustrates another embodiment of BFM fiber laser scheme according to the present invention.

FIG. 32 illustrates a single sub-ring cavity BFM fiber laser scheme according to the present invention.

FIG. 33 illustrates a two sub-ring cavity BFM fiber laser scheme according to the present invention.

FIG. 34 illustrates a three sub-ring cavity BFM fiber laser scheme according to the present invention.

FIG. 35 illustrates an absorber type optical circulator fiber laser scheme according to the present invention.

FIG. 36 illustrates an absorber type BFM fiber laser scheme according to the present invention.

FIG. 37 illustrates a mixed type optical circulator single longitudinal mode fiber laser scheme according to the present invention.

FIG. 38 illustrates another mixed type optical circulator single longitudinal mode fiber laser scheme according to the present invention.

FIG. 39 illustrates a mixed type BFM single longitudinal mode fiber laser scheme according to the present invention.

FIG. 40 illustrates another mixed type BFM single longitudinal mode fiber laser scheme according to the present invention.

### DETAILED DESCRIPTION

The present invention provides a single longitudinal mode fiber laser apparatus. The fiber laser apparatus includes a piece of erbium doped fiber, a wavelength division multiplexer, a pump source, a fiber grating and a polarization controller. At least one sub-ring cavity component or an absorb component are inserted into the cavity for facilitating suppressing laser side modes to create a single longitudinal mode fiber laser. The polarization controller is used to increase stability of the single longitudinal mode fiber laser.

In conventional fiber laser apparatus, line-width of a laser is very wide. Therefore, the present invention is desired to provide an improvement factor into the cavity for facilitating reducing laser side modes. The present invention is mainly for the linear cavity fiber laser by providing optical components into the cavity to suppress laser side modes to create a low cost, simpler and high stability linear cavity fiber laser apparatus.

On the other hand, structure of the improved fiber laser cavity may be introduced. The electronic spectrum of the linear cavity fiber laser is disorder due to unstable polarization state in the resonant cavity. Therefore, configuration of the fiber laser cavity may be constructed as an optical component with polarization stability to reduce longitudinal modes of the linear cavity fiber laser.

In the present invention, Faraday rotator mirror (FRM) is used as a reflection interface at one end of the laser cavity. The polarization direction (angle) of input and output optical signals (bi-directional transmission) is perpendicular for each other by utilizing Faraday rotator mirror to reduce the optical signals interference with each other in erbium doped fiber, and thereby reducing mode number to obtain better fiber laser output.

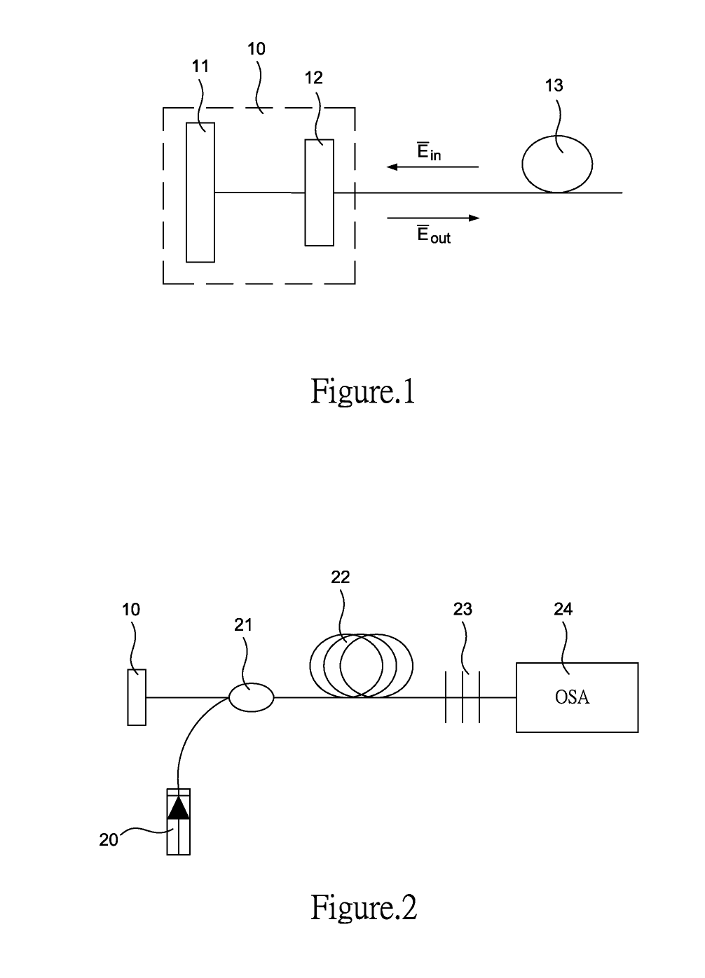

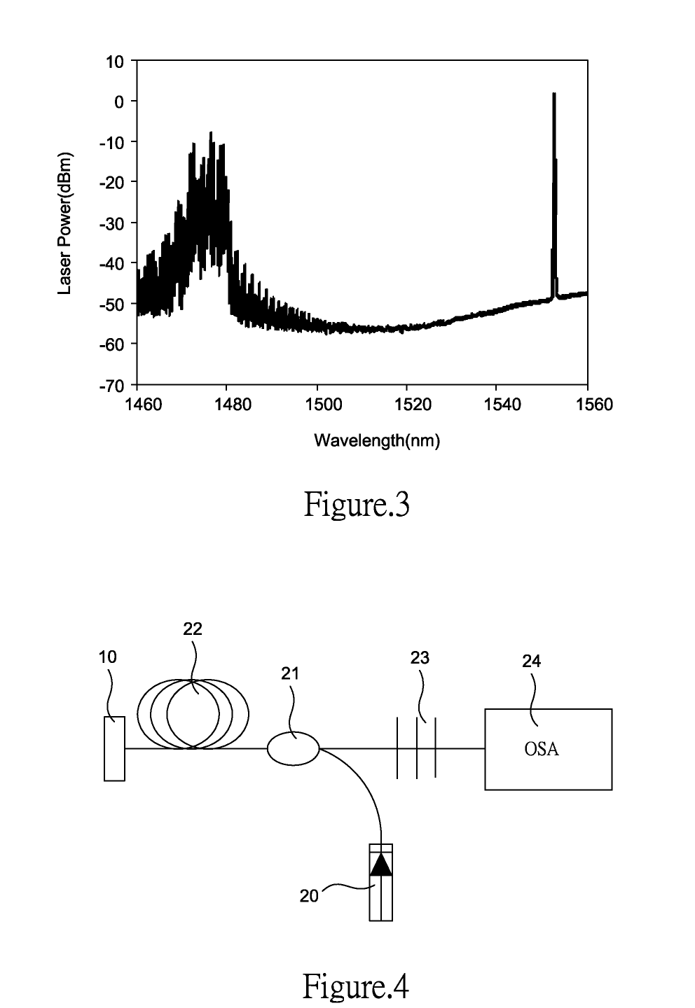

Referring to FIG. 1, it illustrates a Faraday rotator mirror. Faraday rotator mirror 10 is composed of a broadband fiber mirror (BFM) 11 and a Faraday rotator 12. The broadband fiber mirror (BFM) 11 almost completely reflects the incident light (\vec{Eᵢₙ}) back to the cavity, and Faraday rotator 12 rotates the incident light by 45 degrees. As shown in FIG. 1, the polarization degree difference between the incident light and the reflected light (\vec{Eₒᵤₜ}) becomes 90 degrees by utilizing the broadband fiber mirror (BFM) 11 and the Faraday rotator 12. Referring to FIG. 2, it illustrates a FRM type linear fiber laser scheme. Based-on different reflection interface, FRM type erbium doped fiber laser comprises forward pumping scheme and backward pumping scheme. In this embodiment, the forward pumping scheme comprises FRM 10, a piece of erbium doped fiber (EDF) 22, a wavelength division multiplexer (WDM) 21, a fiber grating (FBG) 23, a pump source (PUMP-LD) 20 and an optical spectrum analyzer (OSA) 24. The erbium doped fiber 22 is connected to the fiber Bragg grating 23 and the wavelength division multiplexer 21. The wavelength division multiplexer 21 is connected to the FRM 10 and pump source 20. In one embodiment, pump laser wavelength of the pump source 20 is 1480 nm or 980 nm, and power of 50 mW; reflectivity of the fiber Bragg grating 23 is 50%, and reflective wavelength of 1552.8 nm; absorption coefficient of the erbium doped fiber 22 is 18.79 dB/m at 1530 nm. In the forward pumping scheme, energy provided by the pump laser is forward to the OSA 24, and followed by passing through the erbium doped fiber 22 occurring population inversion. The absorbed energy of the erbium doped fiber 22 is related to the absorption coefficient and length of the erbium doped fiber 22. As shown in FIG. 3, it illustrates an output spectrum of the forward FRM type fiber laser. The erbium doped fiber can not completely absorb energy provided by the pump laser source. In the FIG. 3, residual pump laser is detected by the OSA 24 at about 1480 nm which may reduce the slope efficiency and affect the output power of single longitudinal mode fiber laser.

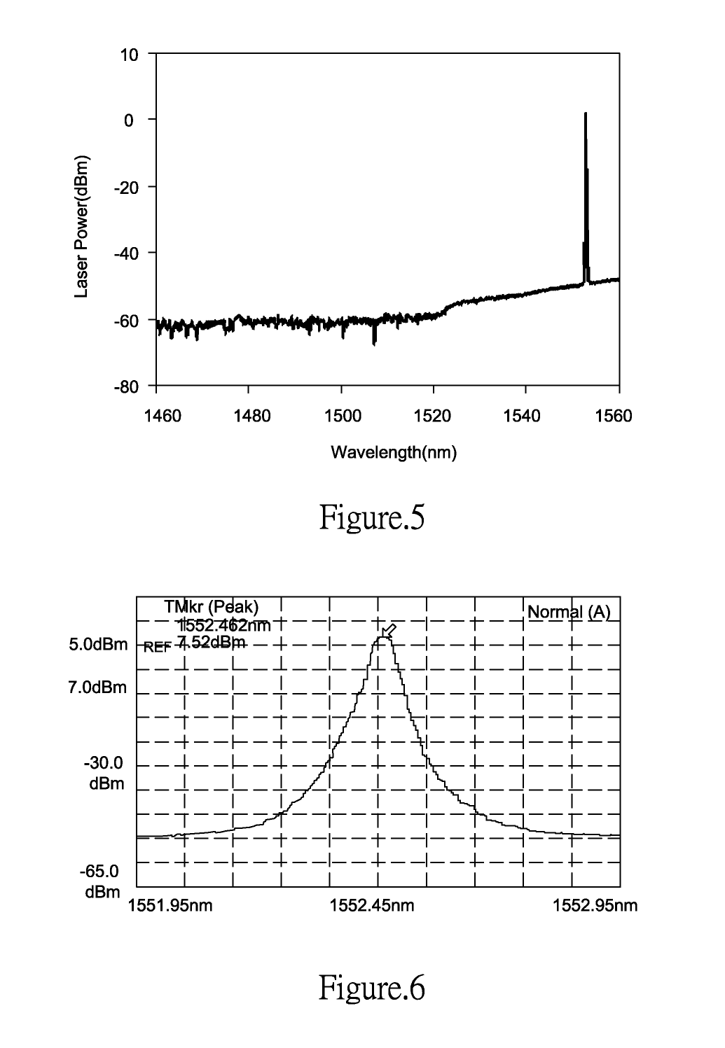

Referring to FIG. 4, it illustrates a backward FRM type linear fiber laser scheme. In this example, the backward pumping scheme comprises FRM 10, a piece of erbium doped fiber (EDF) 22, a wavelength division multiplexer (WDM) 21, a fiber grating (FBG) 23, a pump source (PUMP-LD) 20 and an optical spectrum analyzer (OSA) 24. The erbium doped fiber 22 is connected to the FRM 10 and the wavelength division multiplexer 21. The wavelength division multiplexer 21 is connected to the fiber Bragg grating 23 and pump source 20. In the backward pumping scheme, energy provided by the pump laser is transmitted to the FRM 10. FRM 10 is applied for working wavelength section of C-band which can not significantly reflect energy provided by the pump laser. Therefore, residual pump laser is dissipated at the FRM 10 after the pump laser passing through the erbium doped fiber (EDF) 22 such that only the signal light and the spontaneous emission light is reflected back to the resonant cavity. Accordingly, pure output spectrum of single longitudinal mode laser is achieved at the output end, shown in FIG. 5.

Different length (2 m, 3 m, 4 m or 5 m) of erbium-doped fiber and the selected gain medium will affect output power and signal to noise ratio of a laser. The experiment shows that it has the best output power by using 3 m erbium-doped fiber in the backward pumping scheme which optical spectrum graph shows in FIG. 6, with output power 5.6 mW and signal to noise ratio 57.7 dB. Therefore, the present invention takes an example by 3 m erbium-doped fiber in the backward pumping scheme for realizing single longitudinal mode erbium-doped fiber laser optimization.

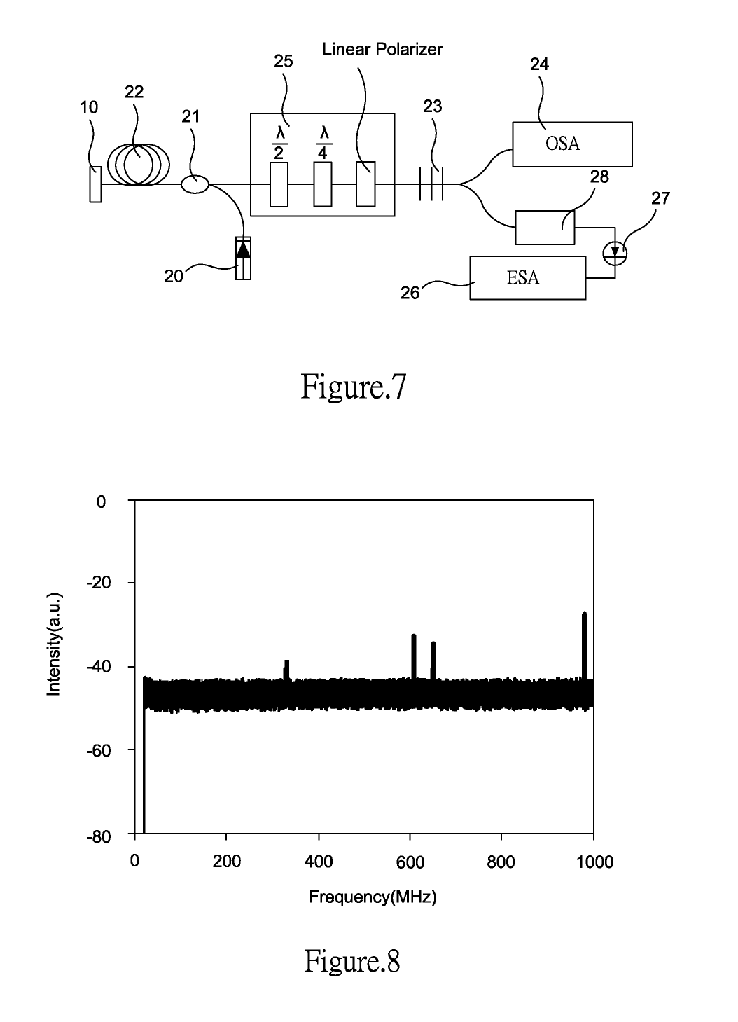

Referring to FIG. 7, it illustrates a FRM type backward pumping scheme with a polarization controller. FRM 10 may optimize polarization state in the cavity while it can not effectively maintain stability of the polarization state in the resonance cavity due to single-mode fiber link. Therefore, in this embodiment, the polarization controller 25 is disposed between the wavelength division multiplexer 21 and the fiber Bragg grating 23 for adjusting polarization angle of light in the resonant cavity, shown in FIG. 7. For example, the polarization controller 25 is composed of a λ/2 polarizer, a λ/4 polarizer and a linear polarizer, wherein λ is optical wavelength.

Referring to FIG. 8, it illustrates an output spectrum of single longitudinal mode fiber laser measured by an electrical spectrum analyzer (ESA) 26. As shown in FIG. 8, it shows that some modes have been suppressed after adjusting by the polarization controller 25. As mentioned above, output of fiber laser is measured by the ESA 26. An optical detector 27 is employed for optical-to-electrical conversion before measuring. Common band of optical communication is about 193 THz in frequency domain which can not directly measured by the electrical spectrum analyzer 26. A delayed self-homodyne (DSH) method is applied for facilitating measuring, and a Mach-Zehnder interferometer 28 is configured prior to the optical detector 27 for facilitating converting.

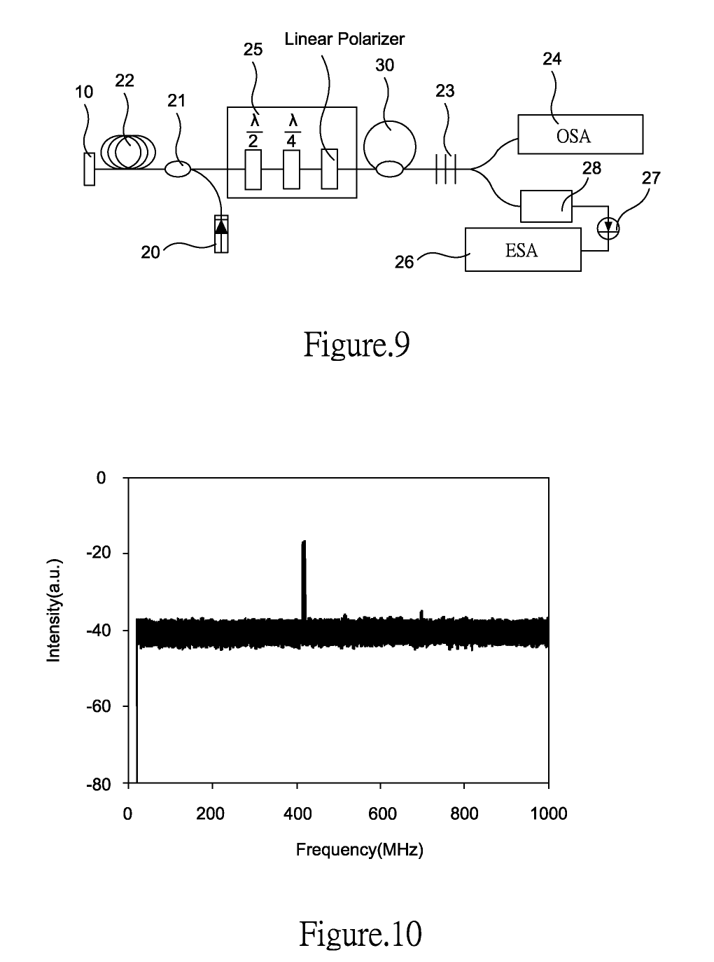

Referring to FIG. 9, it illustrates a FRM type backward pumping scheme with a sub-ring cavity (SRC). The polarization controller 25 is configured between the wavelength division multiplexer 21 and the sub-ring cavity 30. In this embodiment, the sub-ring cavity 30 is used for improving output of a laser, wherein the sub-ring cavity 30 is disposed between the polarization controller 25 and the fiber Bragg grating 23. Length of the sub-ring cavity 30 is for example 0.17 m, 0.3 m or 0.5 m which free spectral range is 1.26 GHz, 714 MHz and 428 MHz, respectively.

In the FRM type backward fiber laser apparatus of the present invention, optical signals in the cavity are amplified by the pump laser and then entering into the erbium-doped fiber 22 via the wavelength division multiplexer 21. Laser signals are draw out of pass-through side of the fiber Bragg grating 23, and output wavelength is determined by reflected wavelength of the fiber Bragg grating 23. Therefore, output power, output linewidth of a laser and mode suppression ratio of single longitudinal mode laser at output side is affected by performance of the fiber grating.

Pump laser produces a power gain via the erbium-doped fiber 22, and followed by entering into FRM 10. Pump laser, twice amplified via the erbium-doped fiber 22, enters into the wavelength division multiplexer 21 such that 1550 nm band laser separates with 1480 nm laser provided by pump laser through wavelength division multiplexing, vice versa. The laser amplified twice via the erbium-doped fiber 22 is entering into the fiber Bragg grating 23, and the reflected laser by the fiber Bragg grating 23 is then back to the cavity. Required laser signals are also draw out of pass-through side of the fiber Bragg grating 23 which have the same wavelength with reflection wavelength of the fiber grating.

When the pump laser passes through the erbium-doped fiber 22 in the first time, laser power is not completely absorbed by the erbium-doped fiber 22. Meanwhile, the unabsorbed power by the erbium-doped fiber 22 is entering into the erbium-doped fiber 22 via the FRM 10 to enhance efficiency of the pump laser and overall efficiency of the erbium-doped fiber 22.

Some side modes of laser spectrum can not be found by OSA 24. Therefore, such side modes may be analyzed by ESA 26. Fiber laser may be down-conversion by Mach-Zehnder interferometer 28 with spectrum range about 1 GHz.

Single longitudinal mode laser of the present invention may be implemented by the following equation. Frequency spacing between the laser modes becomes wider by shortening length of the laser cavity. The adjacent frequency spacing is defined as free spectral range.

FSRₘ=c/nLₘ

Wherein n is reflective index of the fiber, Lₘ is length of the cavity. Based-on the above equation, free spectral range FSRₘ is inverse relation to the length of the cavity. In other words, the shorter length of the cavity is, the wider of the free spectral range is. In the single longitudinal mode fiber laser apparatus of the present invention, for example erbium-doped fiber laser apparatus, length of the cavity is a constant, and fiber length for connecting optical components in the cavity can not be arbitrarily shortened. Therefore, in the present invention, an external passive sub-ring cavity is added into the original laser cavity to alter free spectral range.

For example, structure of the sub-ring cavity 30 of the present invention may be selected as 2×2 optical coupler with 50/50 coupling ratio, which is made by its two ends tieback and another two ends connected to the original linear fiber laser cavity, and two ends connected to the optical coupler as a sub-ring cavity. Length of the sub-ring cavity is a length of single-mode fiber with its two ends connected each other. Based-on such scheme, it can alter free spectral range of the original laser cavity due to the length of the sub-ring cavity much smaller than that of the cavity of the original fiber laser apparatus. Overall free spectral range in the whole cavity may be altered under mutual interacting of two free spectral ranges. For example, frequency spacing may become wider by increasing the number of the sub-ring cavity or shortening the length of the sub-ring cavity. When frequency spacing is over output gain range of the fiber laser, it can generate a single longitudinal mode fiber laser.

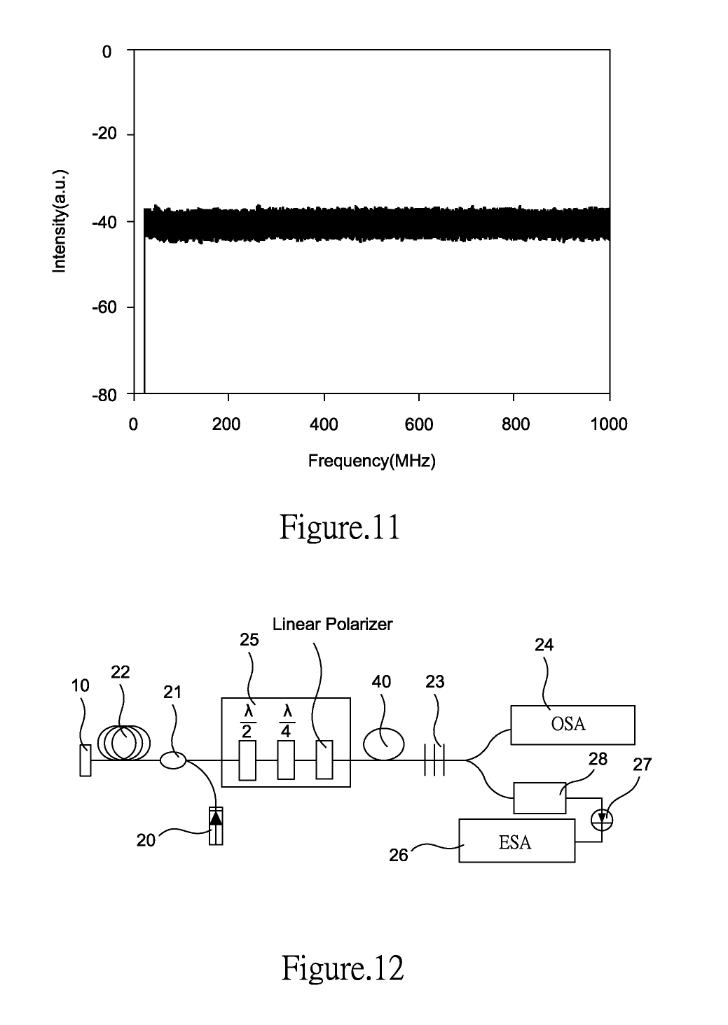

Referring to FIG. 10, it illustrates an electrical spectrum of a FRM type backward fiber laser, with a 0.5 m sub-ring cavity. The electrical spectrum is measured by the ESA 26. As shown in FIG. 10, it can be found that a mode is generated about 400 MHz which is about 428 MHz free spectral range in 0.5 m sub-ring cavity 30. In other words, such found point is the second mode of the fiber laser. In another example, 0.5 m sub-ring cavity 30 replaced by 0.5 m sub-ring cavity 30, it can be found that another mode is created about 800 MHz. Like the measured spectrum in the 0.3 m sub-ring cavity 30, the second mode is found at 800 MHz in 0.5 m sub-ring cavity 30 which has 714 MHz free spectral range. Moreover, electrical spectral in 0.17 m sub-ring cavity 30 is shown in FIG. 11. Free spectral range in 0.17 m sub-ring cavity 30 is 1.26 GHz. No significant modes produce within 1 GHz bandwidth, measured by ESA; and no modes produce beyond 1 GHz bandwidth due to its gain greater than that of the fiber laser itself. Output power of the created single longitudinal mode laser is 0.047 mW, and signal to noise ratio (SNR) is 24.2 dB. Its output power is drop greatly as comparison with that of without mode suppression scheme. In other words, when light passes through the polarization controller 25, a lot of power of light is blocked by the linear polarizer thereof and some different polarization modes are filtered out due to continuous rotation of light polarization by FRM 10 inside the cavity. The polarization controller 25 is used to control the polarization direction of light and improve the stability of the output laser.

According to another aspect of the present invention, it provides an absorber type single longitudinal mode fiber laser apparatus or scheme. Erbium-doped fiber itself has in situ characteristics of absorption and radiation. Optical power will be absorbed by the erbium ions causing loss of power when it is not yet excited by the pump laser. When lights input from both ends of the cavity are controlled such that light interference is occurred inside the cavity, it can reach output of single longitudinal mode laser due to side modes to be suppressed.

In one embodiment, a piece of erbium-doped fiber is used as a basic absorber component which is disposed into the cavity without pump laser passing through. In such characteristics of spontaneous absorption and radiation of erbium-doped fiber will be fairly obvious without pump laser passing through. Backward pumping scheme has advantage than forward bumping scheme, for example twice absorbed by the erbium-doped fiber for simplifying signals and better laser output power.

The present invention prefers adapting the backward pumping fiber laser scheme. Erbium-doped fiber absorber is disposed between the wavelength division multiplexer and the fiber grating. The polarization controller is provided to control the phase of light entering into the erbium-doped fiber absorber such that laser within the erbium-doped fiber absorber produces an interference to achieve the effect of mode suppression.

Different length erbium-doped fiber absorber may be used to observe laser output power and side modes suppression. For example, 1.5 m, 1.0 m, 0.5 m or others length low-doped erbium-doped fiber may be selected to perform light absorption measurements. Modes suppression by adding an absorber component 40 or adjusting erbium-doped fiber absorber length can be found by the ESA 26.

Referring to FIG. 12, it illustrates a FRM type backward pumping scheme with an absorber. In another embodiment, the absorber component 40 is disposed between the polarization controller 25 and the fiber Bragg grating 23. The absorber component 40 is for example a piece of erbium-doped fiber without excited by the pump laser. Light signals forward to the fiber Bragg grating 23 become a linear polarization when passing through the linear polarizer of the polarization controller 25. Therefore, modes suppression via the absorber component 40 can be highly improved due to significant light interference. In one embodiment, the absorber component 40 is a low-doped erbium-doped fiber which absorption coefficient is 6.24 dB/m at wavelength 1530 nm, and length is for example 1.5 m, 1.0 m or 0.5 m. Absorption coefficient of gain erbium-doped fiber is 18.79 dB/m at wavelength 1530 nm, and its length is for example 3.0 m. Output power of laser may be reduce by adjusting doping concentration of the erbium-doped fiber absorber. Under the situation of effectively suppressing modes, low-doped erbium-doped fiber may be selected to reduce the impact for laser output power. In experiment, different lengths erbium-doped fiber absorber can be replaced.

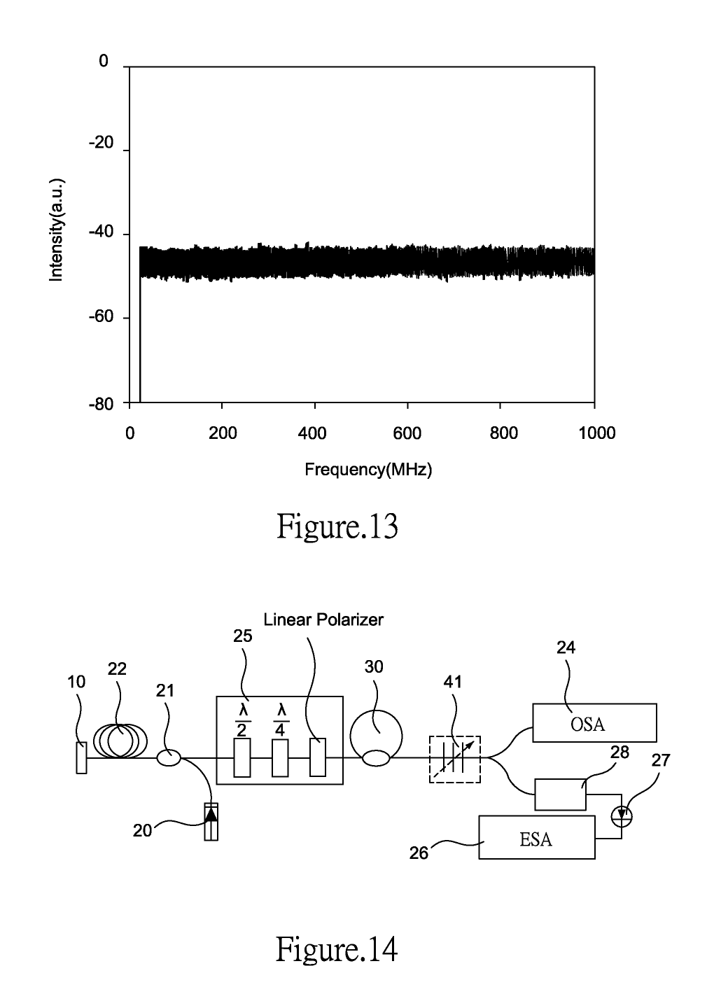

Referring to FIG. 13, it shows an electrical spectral graph of a FRM type backward fiber laser, with a 0.5 m absorber. The electrical spectrum is measured by the ESA 26. The FRM type backward fiber laser, with a 0.5 m, 1.0 m or 1.5 m absorber, has similar electrical spectral graph. As shown in FIG. 13, a 0.5 m, 1.0 m or 1.5 m erbium-doped fiber absorber 40 combining with FRM 10 can also achieve a single longitudinal mode laser. As mentioned above, in the present invention, Faraday rotator mirror (FRM) is used as a reflection interface at one end of the laser cavity which can effectively optimize polarization state inside the resonant cavity to reduce the fiber laser modes. Moreover, based-on various mode suppression schemes, different free spectral range could be found by providing different length of the sub-ring cavity 30 to get a single longitudinal mode laser output. Again, different length of the erbium-doped fiber absorber may be added to filter residual modes for facilitating outputting a single longitudinal mode laser. Table 1 indicates detailed data of single longitudinal mode laser by utilizing different modes suppression schemes in FRM type scheme.

TABLE 1

| | FRM type |
|---|---|
| pumping scheme | backward pumping |
| pumping power | 50 mW@1480 nm |
| FBG reflectivity | 50% |
| gain EDF length | 3 m |

| | | |
|---|---|---|
| mode suppress scheme | sub ring cavity | EDF absorber |
| EDF absorber length (m) | none | 0.5 |
| SRC length (m) | 0.17 | none |
| output power (mW) | 0.04 | 0.08 |
| SNR (dB) | 24.2 | 25.4 |

Based-on the experiment results, it can be found that power changes in the sub-ring cavity FRM type single longitudinal mode laser is about less than 0.04 mW, and power changes in the erbium-doped fiber absorber FRM type single longitudinal mode laser is about less than 0.08 mW. It can be seen that the fiber laser apparatus has an extremely stable power output of laser which is better than a general semiconductor laser (line width about several MHz level).

The fiber grating of the present invention may be a wavelength tunable or fixed wavelength fiber grating as reflection ends of the cavity.

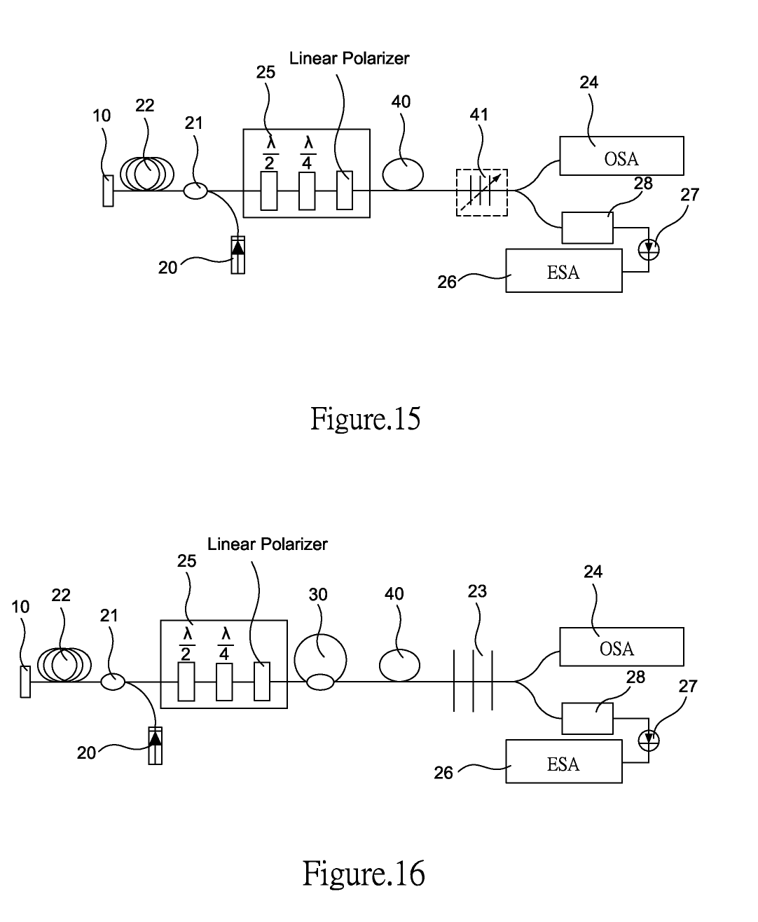

Referring to FIG. 14, it illustrates a FRM type wavelength tunable single longitudinal mode fiber laser scheme with a sub-ring cavity. In this embodiment, it adapts a wavelength tunable grating with the function of wavelength tunable. The fiber Bragg grating 23 is replaced by a wavelength tunable FBG 41. Moreover, in the absorber suppression scheme, a wavelength tunable grating may be applied to obtain the function of wavelength tunable. Similarly, the fiber Bragg grating 23 is replaced by a wavelength tunable FBG 41, shown in FIG. 15. In experiment, it can adjust the state of the longitudinal mode in central wavelength of fiber laser until to reach a single longitudinal mode, followed by applying an external force to the tunable FBG 41 such that wavelength of fiber laser is shift to shorter wavelength or longer wavelength for observing changes of the optical spectrum and the electrical spectrum.

In one embodiment, by adding 0.17 m sub-ring cavity 30 or 0.5 m absorber 40, in the process of wavelength shift of the single longitudinal mode laser, variation of optical power of the above two mode suppression scheme is about 2 dB, and SNR about 2025 dB. Based-on the experiment results, in wavelength tunable FBG scheme, it is found that the electrical spectrum remains single longitudinal mode state with an extremely narrow linewidth when adjusting the wavelength, and therefore it will not affect its mode formation.

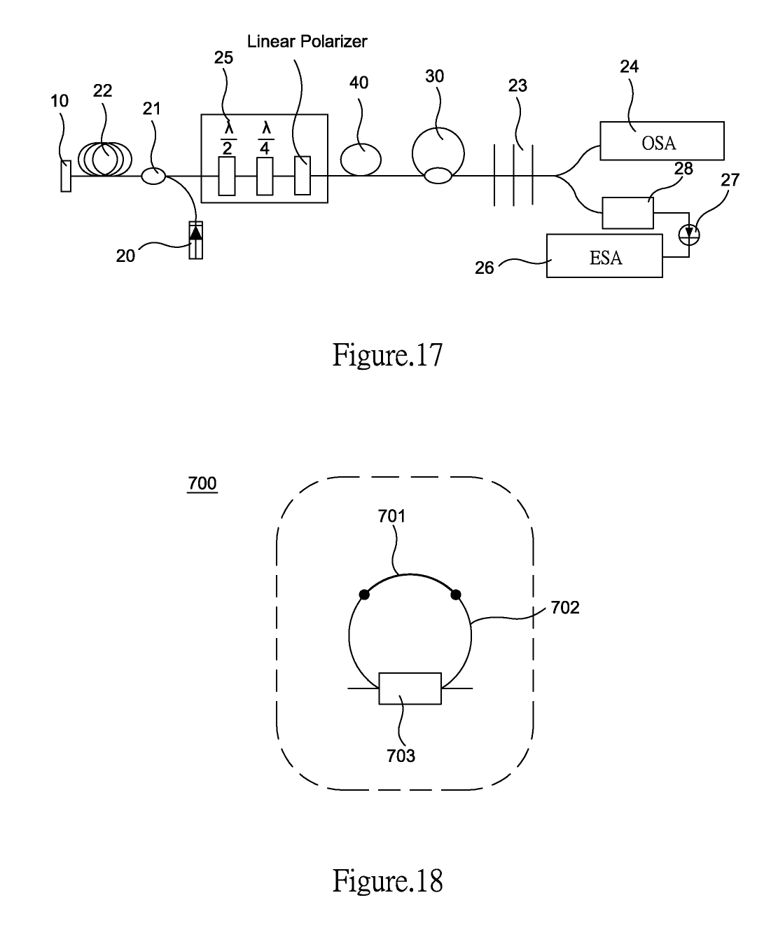

To summarize, according to the above-mentioned embodiments, adding a sub-ring cavity or absorber component into the fiber laser apparatus may completely suppress laser side modes to generate an excellent signal-frequency fiber laser. It should be noted that number of the sub-ring cavity or absorber component is not limited, and a number of sub-ring cavity and/or with the absorber components or with other optical components can be applied to obtain a single longitudinal mode laser. For example, the sub-ring cavity 30 may be combined with the absorber component 40 to construct a mixed type FRM single longitudinal mode fiber laser apparatus or scheme, shown in FIG. 16. In another embodiment, the configuration of the sub-ring cavity 30 and the absorber component 40 may be changeable, for example the absorber component 40 connected to the FBG 23, and the sub-ring cavity 30 connect to the polarization controller 25, shown in FIG. 17. Moreover, in yet another embodiment, a cavity component 700 is disposed in the above mixed type FRM single longitudinal mode fiber laser apparatus or scheme, wherein the cavity component 700 comprises an absorber component 701 configured in part section of the sub-ring cavity 702. The sub-ring cavity 702 is connected to a 2×2 optical coupler 703 with 50/50 coupling ratio, shown in FIG. 18.

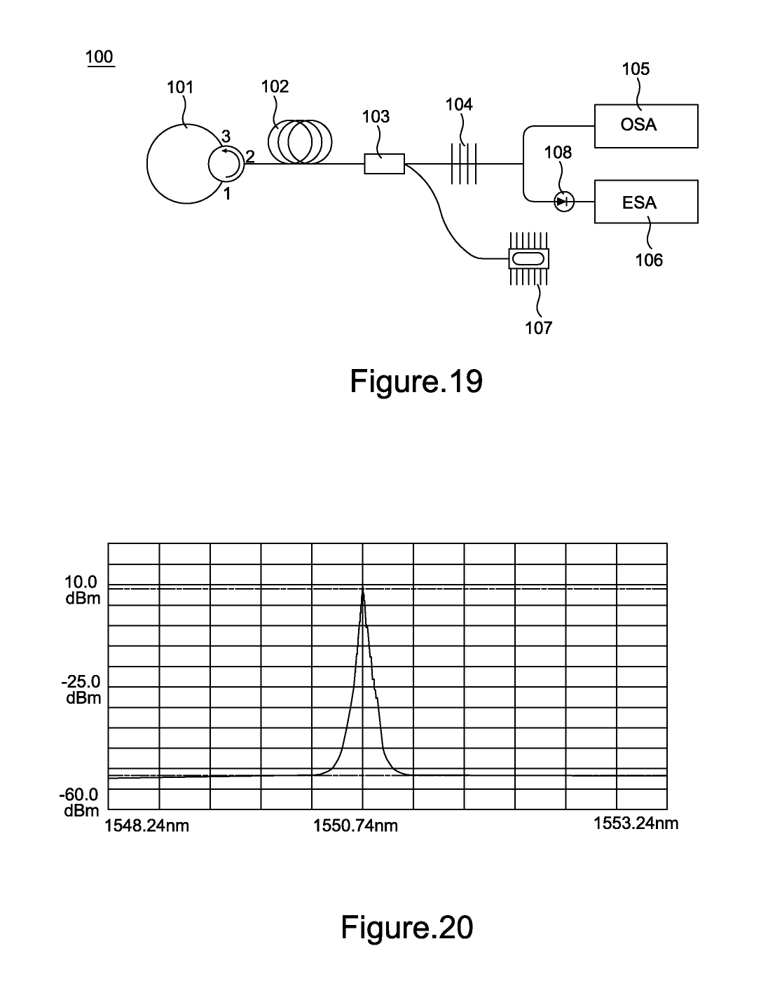

Referring to FIG. 19, it illustrates an optical circulator type fiber laser apparatus. As shown in FIG. 19, the optical circulator type fiber laser apparatus 100 comprises an optical circulator 101, a piece of erbium doped fiber (EDF) 102, a wavelength division multiplexer (WDM) 103, a fiber grating 104, a pump source (PUMP-LD) 107, an optical spectrum analyzer (OSA) 105, a photo-detector 108 and an electrical spectrum analyzer (ESA) 106. Length of the cavity may be 2 m or other sizes. Wavelength of the pump source is 1480 nm or 980 nm. The erbium doped fiber 102 is connected to the optical circulator 101 and the wavelength division multiplexer 103. The wavelength division multiplexer 103 is connected to the fiber grating 104 and pump source 107. The optical circulator 101 is used for one end of the cavity and recycling use of the residual pump power. The fiber grating 104 may be a wavelength tunable and a fixed wavelength fiber grating as reflection ends of the cavity.

The optical circulator type fiber laser apparatus 100 has built-in optical isolator to ensure that the pump laser is not reflected back to output end of the pump source 107 for damaging. Pump laser passing through the erbium-doped fiber 102 produces a power gain, and followed by coupling to a second port of the optical circular 101. Based-on optical properties of the optical circular, laser input the second port of the optical circular 101 is then coupled to a third port of the optical circular 101. And, the third port of the optical circular 101 is connected to a first port of the optical circular 101. Subsequently, laser from the third port is coupling to the first port, and then the first port coupling to the second port, passing through the erbium-doped fiber 102 to increase laser magnification effect.

Meanwhile, the unabsorbed power by the erbium-doped fiber 102 is entering into the erbium-doped fiber 102 via the three ports of the optical circular 101 to enhance efficiency of the pump laser and overall efficiency of the erbium-doped fiber 102.

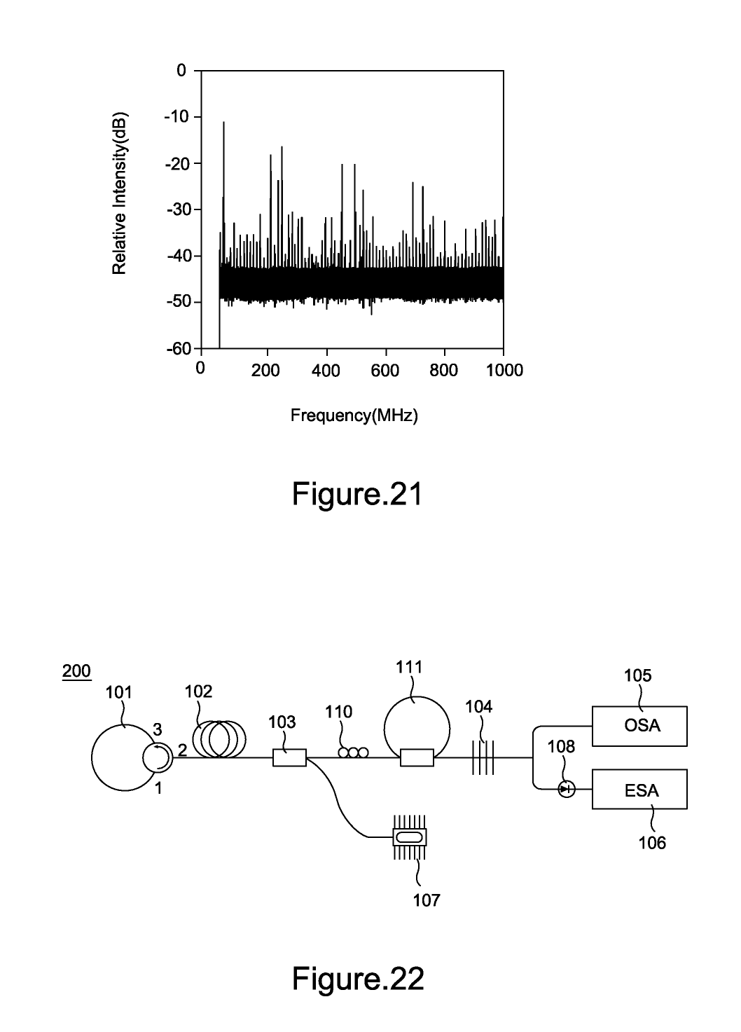

Referring to FIG. 20 and FIG. 21, they illustrate output spectrums of the OSA and ESA of the optical circular type fiber laser apparatus. As shown in FIG. 20, linewidth of a laser produced by the optical circular type or the broadband mirror type fiber laser apparatus is extremely wide. Therefore, the present invention is desired to add an improvement factor into the cavity for facilitating reducing laser side modes. For example, the present invention is provided by adding multiple ring cavity into the cavity to change distribution of longitudinal modes in the original cavity to output a single longitudinal mode laser.

As shown in FIG. 20, the optical circulator fiber laser apparatus is performed in the following measurement conditions: 3 m erbium-doped fiber, 1550 nm central wavelength and reflection ratio 50% of the fiber grating, pump laser power output 50 mW. It can be seen from the FIG. 20 that output power of a laser measured by OSA is 7.29 mW, signal to noise ratio 56.56 dB and threshold power 3.22 mW.

In the present invention, an optical circulator fiber laser apparatus may be as a basic apparatus. In such apparatus, the optical circulator is used as a reflected end of the cavity, such as quasi-ring laser, allows a laser beam propagating in unidirection and blocking reverse signals such that a single longitudinal mode laser has better mode stability than that of the broadband mirror fiber laser. In such apparatus, output of fiber laser is connected to ESA 106 for measuring. It performs a photo-electric conversion by the photo-detector 108 prior to measuring. Due to lower power endurance of the OSA 106, an attenuator (for example 10 dB) may be disposed prior to and connected to the photo-detector 108 for preventing damage.

The present provides an external passive sub-ring cavity by adding into the original laser cavity to alter free spectral range. The above passive component is called as multiple ring cavity (MRC).

Referring to FIG. 22, it illustrates a single sub-ring cavity optical circulator type fiber laser scheme or apparatus 200. Based-on the above basic scheme, in this embodiment, a sub-ring cavity 111 is added to couple to the wavelength division multiplexer (WDM) 103 and the fiber grating 104. For example, length of the sub-ring cavity 111 is 2 m and its free spectral range is about 100 MHz. The polarization controller 110 may be used to control polarization direction of light and improve stability of the output laser. Power difference is about 0.13 dBm between scheme with the polarization controller and the original scheme. In other words, adding the sub-ring cavity 111, output power of a laser is 6.48 mW which reducing about 0.81 mW, and SNR is 56.28 dB which reducing about 0.28 dB. Under the situation by adding such optical components, these power differences are in an acceptable range.

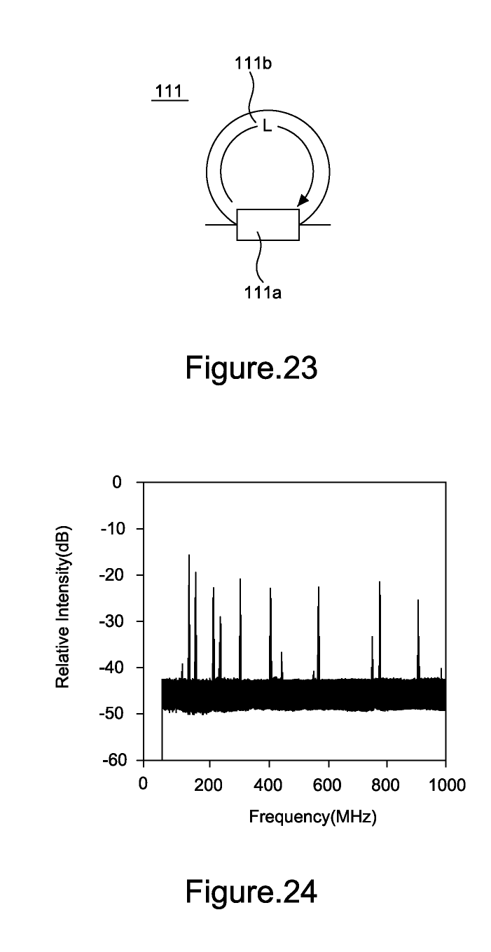

In one embodiment, structure of the sub-ring cavity 111 of the present invention may be selected as 2×2 optical coupler with 50/50 coupling ratio, as shown in FIG. 23, which is made by its two ends tieback and another two ends connected to the original linear fiber laser cavity, and two ends connected to the optical coupler 111a as a sub-ring cavity 111b. Length of the sub-ring cavity 111b is a length of single-mode fiber with its ends connected each other. Based-on such design, it can alter free spectral range of the original laser cavity due to the length of the sub-ring cavity much smaller than that of the cavity of the original fiber laser apparatus. Overall free spectral range in the whole cavity may be altered under mutual interacting of two free spectral ranges. For example, frequency spacing may become wider by increasing the number of the sub-ring cavity or shortening the length of the sub-ring cavity. When frequency spacing is over output gain range of the fiber laser, it can generate a single longitudinal fiber laser.

In the scheme of adding the sub-ring cavity 111, change of spectrum measured by OSA 105 is not much, but variance of spectrum measured by ESA 106 is apparent. As shown in FIG. 24, some laser side modes have been suppressed. Free spectral range in the sub-ring cavity is about 100 MHz. Therefore, it can be seen from the spectrum measured by ESA 106 that frequency about multiple of 100 MHz will generate a longitudinal mode laser. According to this embodiment, multiple of the longitudinal modes laser is generated by adapting single sub-ring cavity which number is less than that of without adding single sub-ring cavity.

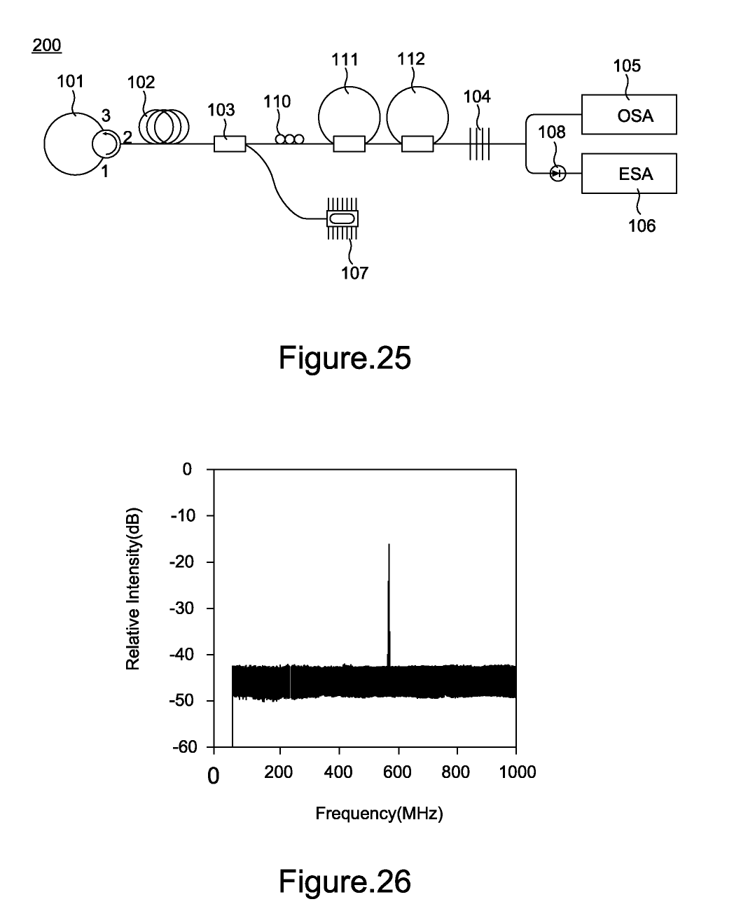

Referring to FIG. 25, it illustrates a single sub-ring cavity optical circulator type fiber laser scheme or apparatus 300. In this embodiment, two sub-ring cavity 111 and 112 is added to couple to the polarization controller 110 and the fiber grating 104. Based-on the above scheme 200, it creates some longitudinal modes laser without reaching the effect of a signal longitudinal mode laser. Therefore, in the scheme of FIG. 25, another sub-ring cavity 112 is added to improve the effect of the fiber laser. Similarly, structure of the sub-ring cavity 112 of the present invention may be selected as 2×2 optical coupler with 50/50 coupling ratio. For example, length of the first sub-ring cavity is 2 m and length of the second sub-ring cavity is 2.2 m. In this embodiment, for power variation on OSA 105 via two sub-ring cavities, power is reducing to 4.72 mW, and SNR is reducing to 54.6 dB. It can be seen in ESA 106 that overall free spectral range in the whole cavity may be altered under mutual interacting of two free spectral ranges responding to the sub-ring cavity 111 and 112 which have about 100 MHz and 92 MHz free spectral ranges, respectively. Taking a least common multiple of above two numbers with the main cavity, it can be found about 580 MHz free spectral range, shown in FIG. 26. In FIG. 26, it can be seen on ESA 106 that only common multiple of above two sub-ring cavity's free spectral ranges outputs longitudinal modes of laser. It is noted that two sub-ring cavity may be adapted to effectively suppress laser side modes.

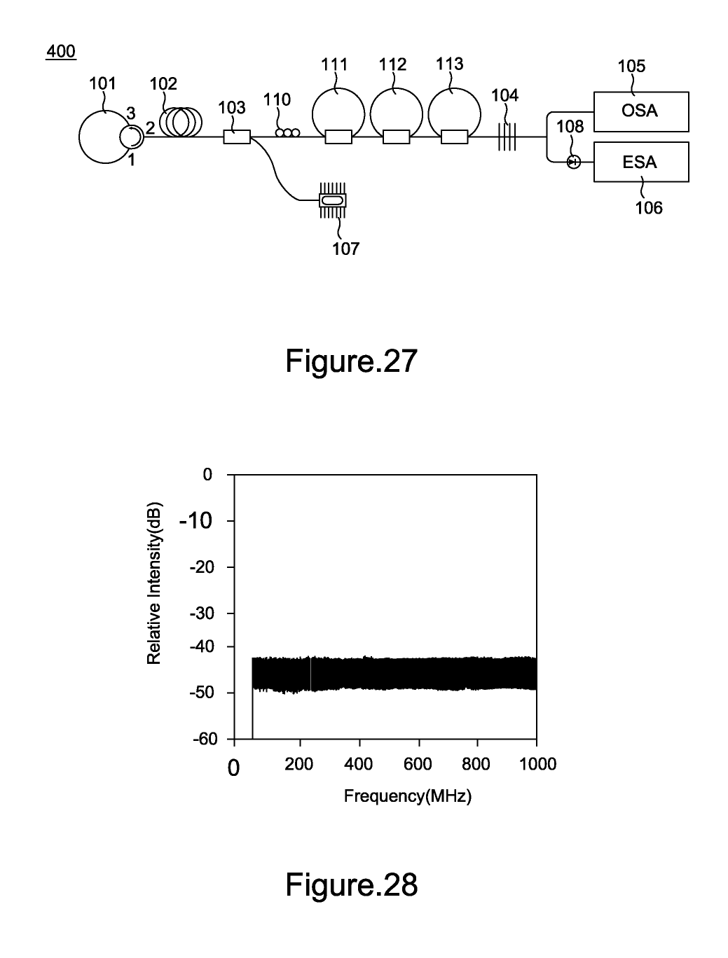

From above-mentioned embodiments, it is asserted that multiple sub-ring cavity can be adapted to reduce number of the laser longitudinal modes and effectively suppress laser side modes. While it needs to laser side modes completely suppressed if it desired to reach a single longitudinal mode laser. Next, additional sub-ring cavity 113 is added to further improve the laser effect, as shown in FIG. 27. Similarly, structure of the sub-ring cavity 113 of the present invention may be selected as 2×2 optical coupler with 50/50 coupling ratio.

Referring to FIG. 27, it illustrates a multiple sub-ring cavity optical circulator type fiber laser scheme or apparatus 400. In this embodiment, sub-ring cavity 111, 112 and 113 is added to couple to the polarization controller 110 and the fiber grating 104. Based-on the above scheme, it creates few longitudinal modes laser by adding two sub-ring cavity 111 and 112, and therefore a third sub-ring cavity 113 is added to further suppress laser side modes. For example, length of the added third sub-ring cavity 113 is 3.5 m. Free spectral range may be over gain range of the output of fiber laser under mutual interacting of three sub-ring cavity 111, 112 and 113. It can be seen in ESA 106 that laser side modes are completely disappeared, as shown in FIG. 28, and therefore an excellent single longitudinal laser is generated.

It is seen on OSA 105, output power of a laser is reducing to 3.05 mW from 7.29 mW, which reducing about 4.24 mW, and SNR is reducing to 52.64 dB from 56.56 dB, which reducing about 3.92 dB. Under the situation by adding such optical components, these power differences are in an acceptable range.

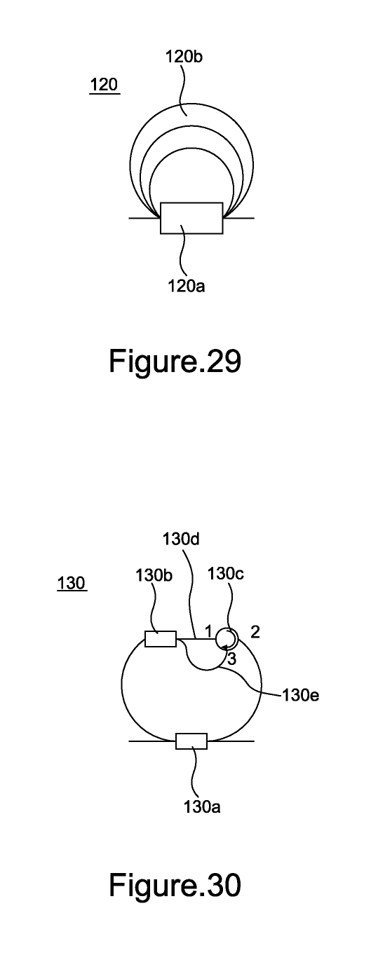

It is noted that number of the sub-ring cavity component of the present invention is not limited, and other number of the sub-ring cavity component and/or combining with others optical components may produce a single longitudinal fiber laser. In one embodiment, structure of the multiple sub-ring cavity component 120 may be selected as a 4×4 optical coupler 120a with three different length sub-ring cavity tieback and coupled to the 4×4 optical coupler 120a, coupling ratio depending on application, as shown in FIG. 29. In such embodiment, it is utilized to increase number of the sub-ring cavity to effectively obtain wider frequency spacing. While the frequency spacing is over gain range of the output of fiber laser, it can produce a signal longitudinal mode laser. In another embodiment, structure of the multiple sub-ring cavity component 130 may be selected as two 2×2 optical coupler 130a, 130b and an optical circulator 130c with different length/path sub-ring cavity to effectively obtain wider frequency spacing. 2×2 optical coupler 130a and 130b has 50/50 coupling ratio or others ratio, shown in FIG. 30. 2×2 optical coupler 130a and 130b and first port and second port of the optical circulator 130c are string connection into the multiple sub-ring cavity to form first optical path 130d, and 2×2 optical coupler 130a and 130b and the second port and third port of the optical circulator 130c are string connection into the multiple sub-ring cavity to form second optical path 130e. In this embodiment, based-on function of the optical circulator 130c, there are different paths 130d and 130e are formed in the multiple sub-ring cavity, and thereby effectively obtaining wider frequency spacing. Similarly, when the frequency spacing is over gain range of the output of fiber laser, a signal longitudinal mode fiber can be produced.

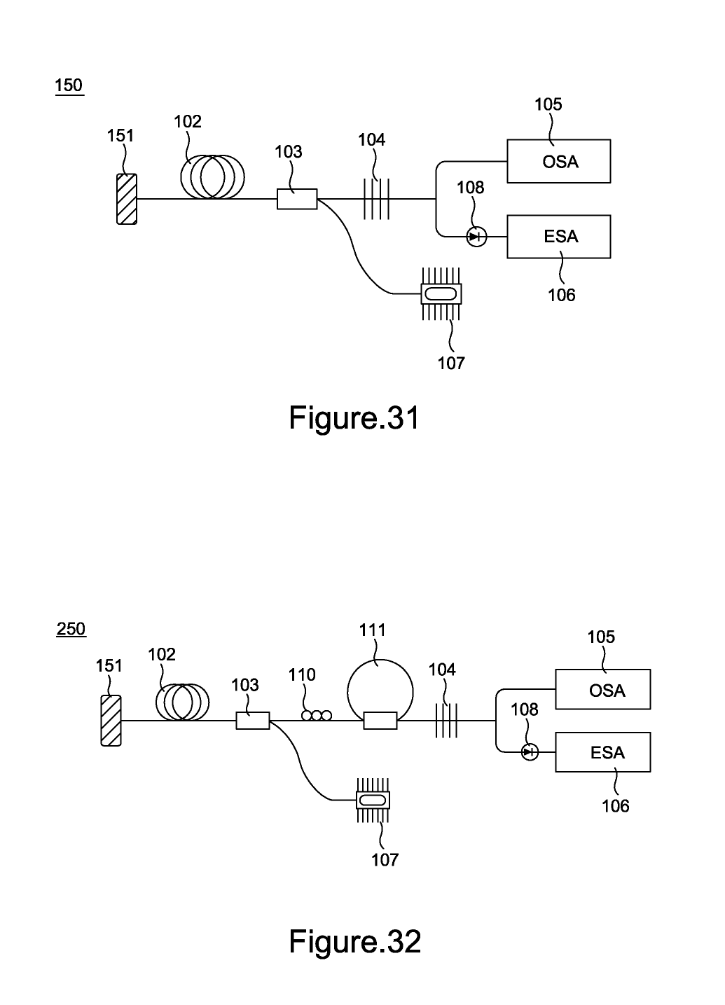

Referring to FIG. 31, it illustrates another embodiment of BFM fiber laser scheme or apparatus 150. In this embodiment, most of the components and parameters are the same as the above optical circulator type fiber laser scheme. The difference between two schemes is one reflected end replaced by broadband fiber mirror (BFM) 151, and therefore the detailed descriptions are omitted. BFM 151 is coupled to the erbium doped fiber (EDF) 102. Based-on the experiment results, it can be found that output power of a laser is 7.96 mW, SNR 57.68 and threshold power 3.12 mW which is better than that of the optical circulator fiber laser. It can be seen that output of a laser is still affecting by some side modes, and therefore multiple sub-ring cavity may be added to suppress these side modes.

Referring to FIG. 32, it illustrates a single sub-ring cavity BFM fiber laser scheme or apparatus 250. In this embodiment, a single sub-ring cavity component 111 is added into the original cavity of the above scheme. The sub-ring cavity with length 2 m is adding into the original cavity. A polarization controller 110 is configured to stabilize laser output. The power difference is about 0.05 dBm due to adding the polarization controller 110 which impact to the laser output is extremely small. The output power of a laser is 6.43 mW, which reducing about 1.53 mW, SNR 56.28 dB via single sub-ring cavity component 111. It can be found on ESA 106 that side modes have been highly reduced and free spectral range between modes has been altered due to 2 m sub-ring cavity.

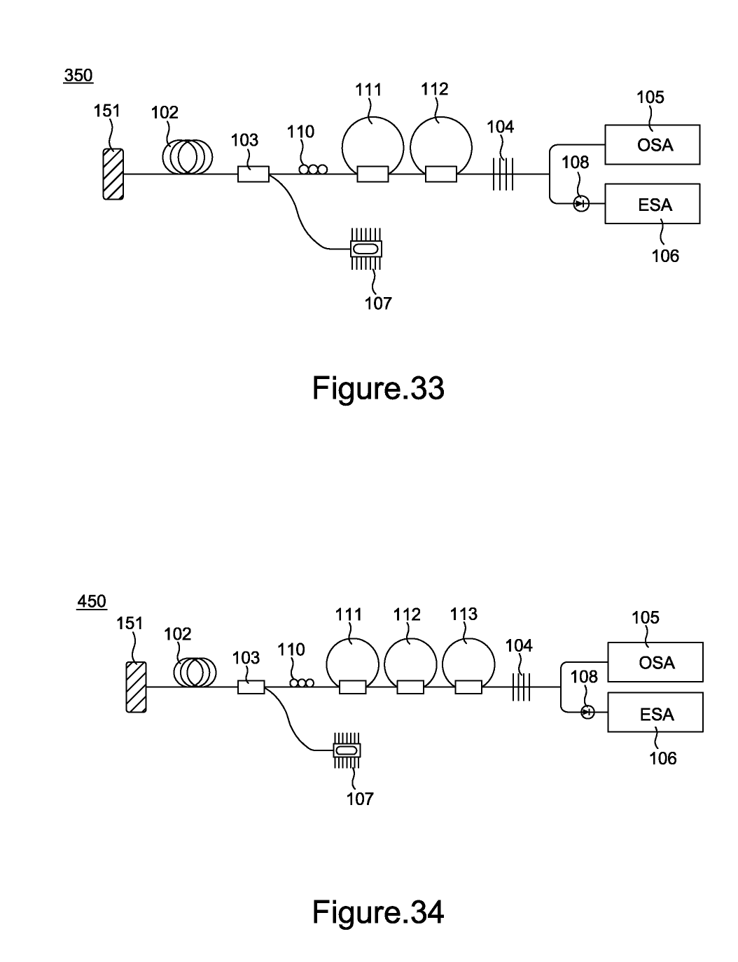

Referring to FIG. 33, it illustrates a two sub-ring cavity BFM fiber laser scheme or apparatus 350. In this embodiment, two sub-ring cavity components 111 and 112 are added into the original cavity of the above scheme. The output power of a laser is reducing to 5.27 mW, SNR 55.44 dB via the two single sub-ring cavity components 111 and 112. It can be found on ESA 106 that side modes have also been highly reduced to produce a longitudinal mode laser output.

Side mode impact should be reducing to minimum if it is desired to reach a single longitudinal mode laser. Therefore, an additional sub-ring cavity component 113 is added to suppress side modes. Referring to FIG. 34, it illustrates a three sub-ring cavity BFM fiber laser scheme or apparatus 450. In this embodiment, three sub-ring cavity components 111, 112 and 113 are added into the original cavity of the above scheme. The output spectrum analyzed by OSA 105 and ESA 106 is similar with the optical circulator scheme. Laser side modes are completely suppress via three sub-ring cavity, and thereby generating a single longitudinal mode laser. The output power of a laser is 3.82 mW, which reducing about 4.14 mW comparison with non-added sub-ring cavity, SNR 53.76 dB, reducing about 3.92 dB comparison with non-added sub-ring cavity via three sub-ring cavity components. It can be found on ESA 106 that side modes have also been highly reduced to generate a longitudinal mode laser output.

As above-mentioned embodiments, it asserted that length of the cavity will impact laser output.

Based-on the experiment results, it can be found that power changes of the multiple sub-ring cavity optical circulator type single longitudinal mode fiber laser is about less than 0.04 mW, and power changes of the multiple sub-ring cavity FBM type single longitudinal mode fiber laser is about less than 0.06 mW. It can be seen that the fiber laser apparatus has a very stable laser power output which is better than a general semiconductor laser (line width about several MHz level).

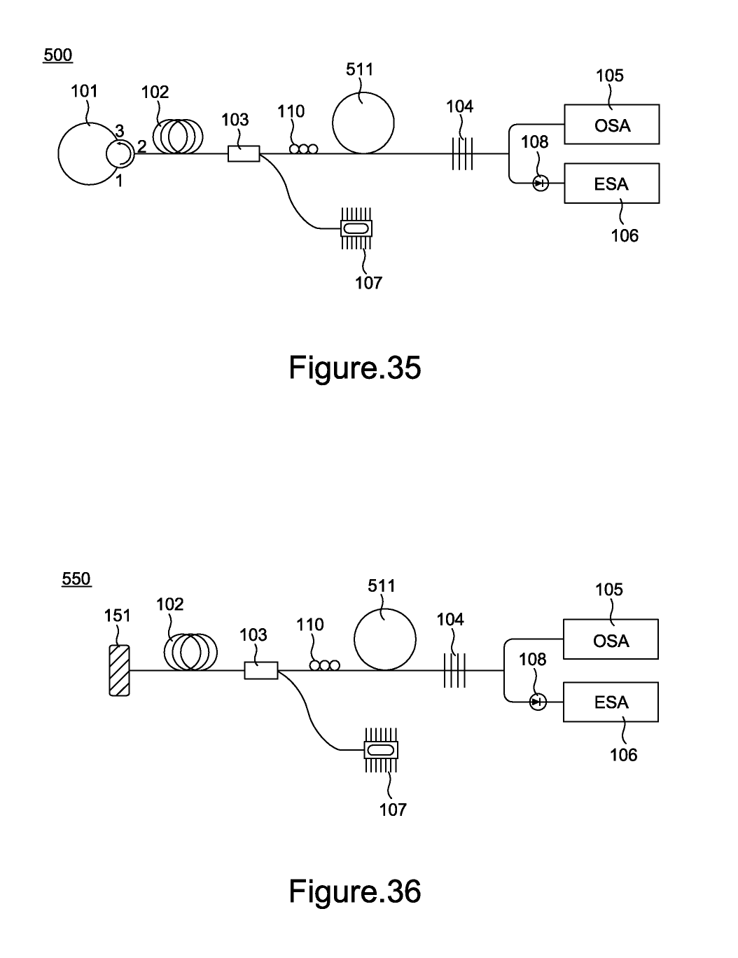

Referring to FIG. 35, it illustrates an absorber type optical circulator fiber laser scheme 500. In this embodiment, an absorber component 511 is disposed between the polarization controller 110 and the fiber grating 104. The absorber component 511 is for example a piece of erbium-doped fiber. In this embodiment, most of the components and parameters are the same as the above optical circulator type fiber laser scheme. The difference between two schemes is multiple sub-ring cavity replaced by the absorber component 511, and therefore the detailed descriptions are omitted.

Referring to FIG. 36, it illustrates an absorber type BFM fiber laser scheme 550. In this embodiment, an absorber component 511 is disposed between the polarization controller 110 and the fiber grating 104. The absorber component 511 is not limited a piece of erbium-doped fiber. In this embodiment, the optical circulator 101 is replaced by the BFM 151.

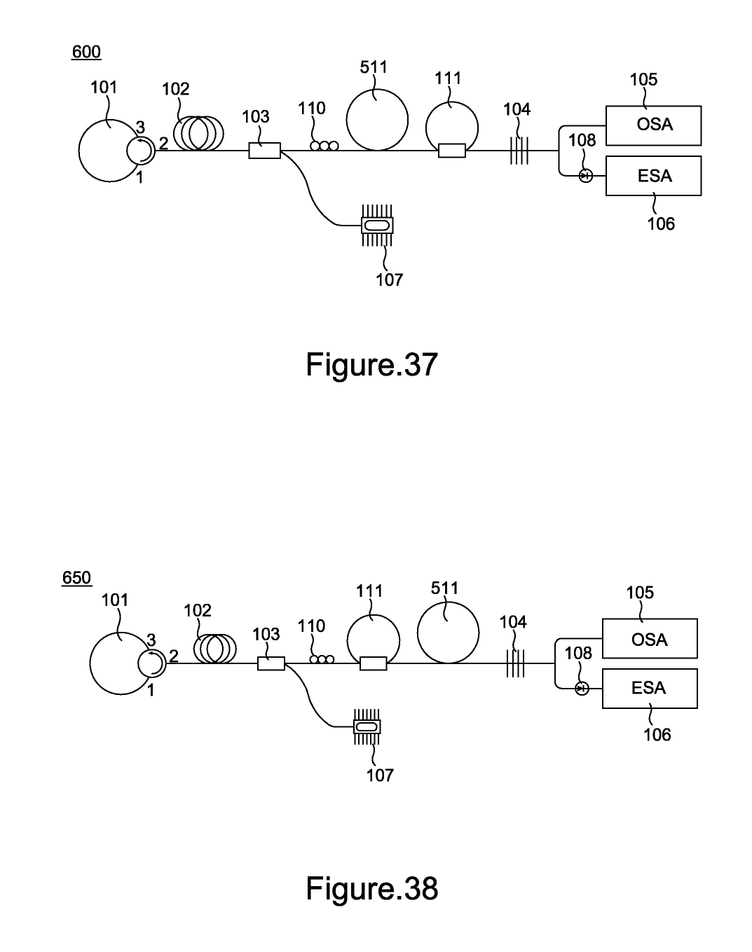

Moreover, according to an aspect of the present invention, it provides a mixed type optical circulator single longitudinal mode fiber laser apparatus or scheme. In this embodiment, the absorber component 511 may be combined with the sub-ring cavity 111 to construct a mixed type optical circulator single longitudinal mode fiber laser apparatus or scheme 600, shown in FIG. 37. The absorber component 511 is connected to the polarization controller 110, and the sub-ring cavity component 111 is coupled to the fiber grating 104. In another embodiment, the configuration of the absorber component 511 and the sub-ring cavity component 111 may be changeable, for example the absorber component 511 connected to the FBG 104, and the sub-ring cavity 111 connect to the polarization controller 110, shown in FIG. 38.

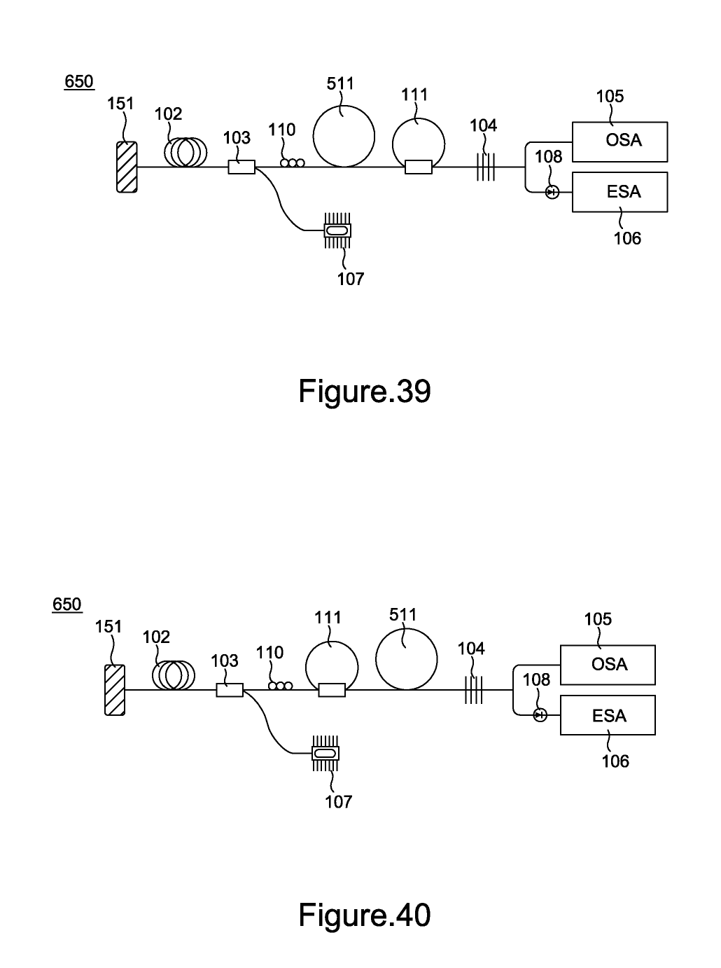

In another embodiment, the optical circulator 101 replaced by BFM 151, it provides a mixed type BFM single longitudinal mode fiber laser apparatus or scheme 650, shown in FIG. 39. Similarly, the configuration of the absorber component 511 and the sub-ring cavity component 111 may be changeable, for example the absorber component 511 connected to the FBG 104, and the sub-ring cavity 111 connect to the polarization controller 110, shown in FIG. 40.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A single longitudinal mode fiber laser apparatus, comprising:
a fiber component;
a wavelength division multiplexer coupled to said fiber component;
a pump source coupled to said wavelength division multiplexer;
a wavelength tunable or wavelength non-tunable as a front cavity end for said fiber laser apparatus; and
at least one sub-ring cavity component inserting into said cavity for facilitating suppressing laser side modes to create a single longitudinal mode fiber laser.

2. The apparatus of claim 1, further comprising a Faraday rotator mirror coupled to said fiber component.

3. The apparatus of claim 2, wherein said Faraday rotator mirror comprises a broadband fiber mirror and a Faraday rotator.

4. The apparatus of claim 1, further comprising a polarization controller coupled said wavelength division multiplexer and said sub-ring cavity component.

5. The apparatus of claim 1, further comprising an optical circulator coupled to said fiber component.

6. The apparatus of claim 1, further comprising a broadband fiber mirror coupled to said fiber component.

7. The structure of claim 1, wherein said sub-ring cavity component comprises a first optical coupler, a second optical coupler and an optical circulator, wherein said first optical coupler, said second optical coupler and said optical circulator are serially configured into a sub-ring cavity to form two optical paths.

8. A single longitudinal mode fiber laser apparatus, comprising:
a fiber component;
a wavelength division multiplexer coupled to said fiber component;
a pump source coupled to said wavelength division multiplexer;
a wavelength tunable or wavelength non-tunable as a front cavity end for said fiber laser apparatus; and
an absorber component inserting into said cavity for facilitating suppressing laser side modes to create a single longitudinal mode fiber laser.

9. The apparatus of claim 8, further comprising a Faraday rotator mirror coupled to said fiber component.

10. The apparatus of claim 9, wherein said Faraday rotator mirror comprises a broadband fiber mirror and a Faraday rotator.

11. The apparatus of claim 8, further comprising a polarization controller coupled said wavelength division multiplexer and said absorber component.

12. The apparatus of claim 8, further comprising an optical circulator coupled to said fiber component.

13. The apparatus of claim 1, further comprising a broadband fiber mirror coupled to said fiber component.

14. A single longitudinal mode fiber laser apparatus, comprising:
a fiber component;
a wavelength division multiplexer coupled to said fiber component;
a pump source coupled to said wavelength division multiplexer;
a wavelength tunable or wavelength non-tunable as a front cavity end for said fiber laser apparatus; and
an absorber and at least one sub-ring cavity component inserting into said cavity for facilitating suppressing laser side modes to create a single longitudinal mode fiber.

15. The apparatus of claim 14, further comprising a Faraday rotator mirror coupled to said fiber component.

16. The apparatus of claim 15, wherein said Faraday rotator mirror comprises a broadband fiber mirror and a Faraday rotator.

17. The apparatus of claim 14, further comprising a polarization controller coupled said wavelength division multiplexer and said sub-ring cavity component.

18. The apparatus of claim 14, further comprising an optical circulator coupled to said fiber component.

19. The apparatus of claim 14, further comprising a broadband fiber mirror coupled to said fiber component.

20. The structure of claim 14, wherein said absorber component is coupled to said at least one sub-ring cavity component and/or said absorber component is inserted into said at least one sub-ring cavity component.
